(19) United States
(12) Patent Application Publication
(10) Pub. No.: US 2026/0302785 A1
(43) Pub. Date: Oct. 1, 2026

(54) SYSTEM, METHOD, AND COMPUTER READABLE STORAGE MEDIUM

(71) Applicant: HONDA MOTOR CO.,LTD., Tokyo (JP)

(72) Inventors: Tatsuya UCHIMOTO, Tokyo (JP); Shohei NAKAMURA, Tokyo (JP); John HOLMES, San Diego, CA (US)

(21) Appl. No.: 19/095,067

(22) Filed: Mar. 31, 2025

(51) Int. Cl. H02J 3/32

(52) U.S. Cl. CPC H02J 3/32; H02J 2101/24; H02J 2105/37

(57) ABSTRACT

[Solving Means] The system includes a stop unit which stops a supply of generated power, from a power generation apparatus which is connected to the power grid, to the power grid; and a transition control unit which in a first state in which power is not supplied from another power grid to the power grid, causes the stop unit to stop the supply of the generated power from the power generation apparatus to the power grid, when a first condition is satisfied, stores a resumption time, from when the supply of the generated power from the power generation apparatus is stopped by the stop unit, to when the supply of the generated power from the power generation apparatus is resumed, and performs a transition control to transition from the first state to a second state in which the power is able to be supplied from the another power grid to the power grid, based on the resumption time, when a second condition is satisfied.

### BACKGROUND

### 1. Technical Field

The present invention relates to a system, a control method, and a computer-readable storage medium.

### 2. Related Art

Patent Document 1 discloses a technique for controlling a frequency of an AC side output voltage to be high in order to disconnect a photovoltaic power generation system from a charging and discharging apparatus in a power outage operation mode.

### PRIOR ART DOCUMENTS

### Patent Document

Patent Document 1: Japanese Patent No. 7113951

### BRIEF DESCRIPTION OF THE DRAWINGS

FIG. 1 shows an overall configuration of a system 5 according to an embodiment.

FIG. 2 shows an example of a system configuration related to a control function of a charging and discharging apparatus 12.

FIG. 3 is a conceptual diagram for describing a synchronization control that is included in a transition control performed by a transition control unit 220.

FIG. 4 is a diagram for describing a case in which generated power of a power generation apparatus 15 becomes excessive when the synchronization control is being executed between a power state of a first power grid 13 and a power state of a second power grid 19.

FIG. 5 is a diagram for describing a control for stopping a supply of the generated power of the power generation apparatus 15, when the synchronization control is performed between the power state of the first power grid 13 and the power state of the second power grid 19.

FIG. 6 shows a flowchart related to a control method that is executed in the system 5.

FIG. 7 is a flowchart related to processing when the second power grid 19 is determined to be in a normal state in S608 of FIG. 6.

FIG. 8 shows an example of a computer 5000.

### DESCRIPTION OF EXEMPLARY EMBODIMENTS

The present invention will be described below through embodiments of the invention, but the following embodiments do not limit the invention according to the claims. In addition, not all of the combinations of features described in the embodiments are essential to the solution of the invention.

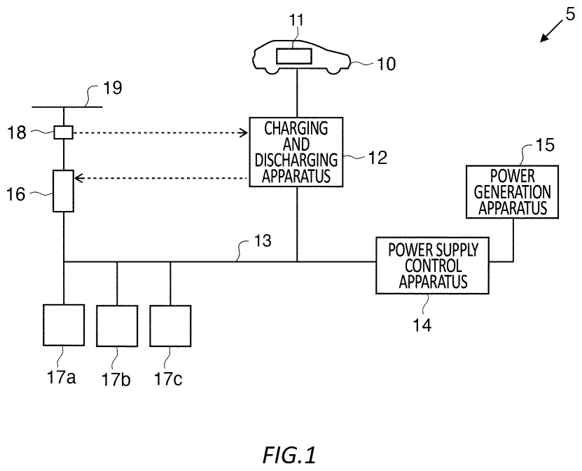

FIG. 1 shows an overall configuration of a system 5 according to an embodiment. The system 5 includes: a charging and discharging apparatus 12; a power supply control apparatus 14; a power generation apparatus 15; an opening and closing unit 16; a vehicle 10; a power load 17a, a power load 17b, and a power load 17c; and a detection unit 18. In the present embodiment, the power load 17a, the power load 17b, and the power load 17c are collectively referred to as a “power load 17”. The charging and discharging apparatus 12, the power supply control apparatus 14, the opening and closing unit 16, the vehicle 10, and the power load 17 are at least electrically connected to a first power grid 13.

The first power grid 13 is a power grid in a power consumer. The power consumer includes a home, a business establishment, a factory, or the like. The power load 17 is connected to the first power grid 13. The power load 17 consumes power that is supplied from the first power grid 13. The power load 17 is, for example, electrical equipment such as a lighting apparatus.

The first power grid 13 is connected to a second power grid 19 via the opening and closing unit 16. The second power grid 19 is, for example, a power grid of a commercial power system. The first power grid 13 can be supplied with power from the second power grid 19. The first power grid 13 is an example of a “power grid”, and the second power grid 19 is an example of “another power grid”.

The detection unit 18 detects a voltage, a frequency, and a phase of the second power grid 19. The opening and closing unit 16 switches a connection state between the first power grid 13 and the second power grid 19. When the opening and closing unit 16 is in a closed state, the first power grid 13 is connected to the second power grid 19. When the opening and closing unit 16 is in an open state, the first power grid 13 is disconnected from the second power grid 19. The opening and closing unit 16 is able to be in the open state at a time of a power outage of the second power grid 19, and be in a closed state at a time when the power is restored to the second power grid 19.

The power generation apparatus 15 generates power. The power generation apparatus 15 is, for example, a photovoltaic power generation apparatus. The power generation apparatus 15 may be a power generation apparatus which generates the power by using natural energy such as wind power. The power supply control apparatus 14 supplies, to the first power grid 13, the power (generated power) generated by the power generation apparatus 15. When the power generation apparatus 15 generates DC power, the power supply control apparatus 14 converts the DC power generated by the power generation apparatus 15, into AC power to supply the AC power to the first power grid 13. The power supply control apparatus 14 is, for example, a power conditioner.

The vehicle 10 is an electric motor vehicle. The vehicle 10 is equipped with a power storage apparatus 11. The power storage apparatus 11 stores electrical energy for the vehicle 10 to travel. The vehicle 10 is an electric vehicle, a plug-in hybrid vehicle, or the like. The power storage apparatus 11 is a secondary battery. For example, the power storage apparatus 11 is a lithium ion battery, a nickel-metal hydride battery, or the like.

The charging and discharging apparatus 12 controls an exchange of power between the power storage apparatus 11 and the first power grid 13. The charging and discharging apparatus 12 charges the power storage apparatus 11 with the power that is supplied from the first power grid 13. For example, the charging and discharging apparatus 12 converts the AC power that is supplied from the first power grid 13, into the DC power to charge the power storage apparatus 11. The charging and discharging apparatus 12 is able to supply, to the first power grid 13, the power (which may be referred to as “discharged power”) generated by the electrical energy accumulated in the power storage apparatus 11. For example, the charging and discharging apparatus 12 converts the DC power generated by discharging the power storage apparatus 11, into the AC power to supply the AC power to the first power grid 13.

The charging and discharging apparatus 12 has a function of performing an independent operation during a power outage. During the power outage of the second power grid 19, the opening and closing unit 16 is in an open state, and the discharged power of the power storage apparatus 11 is supplied to the first power grid 13 and/or the power supply control apparatus 14. The power supply control apparatus 14 is started by receiving the power supply from the charging and discharging apparatus 12, and makes it possible to supply, to the first power grid 13, the generated power of the power generation apparatus 15. The power load 17 is able to be operated by the discharged power of the power storage apparatus 11 and/or the generated power of the power generation apparatus 15. In another embodiment, the power supply control apparatus 14 may have a function of performing the independent operation during the power outage.

The charging and discharging apparatus 12 has a function of controlling the first power grid 13. Specifically, during a power outage of the second power grid 19, the charging and discharging apparatus 12 is able to control the voltage, the frequency, and the phase of the first power grid 13 by using the discharged power of the power storage apparatus 11. The power supply control apparatus 14 adjusts the AC power that is generated based on the generated power of the power generation apparatus 15, according to the voltage, the frequency, and the phase of the first power grid 13 controlled by the charging and discharging apparatus 12; and supplies the adjusted AC power to the first power grid 13.

When the generated power from the power supply control apparatus 14 falls below the power that is consumed by the power load 17, the charging and discharging apparatus 12 makes up for a power shortage with the discharged power of the power storage apparatus 11. When the generated power from the power supply control apparatus 14 exceeds the power that is consumed by the power load 17, the charging and discharging apparatus 12 charges the power storage apparatus 11 by using surplus power.

When the power is restored to the second power grid 19, the charging and discharging apparatus 12 switches the operation of the first power grid 13 to a grid-connected operation. When the power is restored to the second power grid 19, the charging and discharging apparatus 12 controls the voltage, the frequency, and the phase in the first power grid 13 such that the voltage, the frequency, and the phase in the first power grid 13 are synchronized with the voltage, the frequency, and the phase of the second power grid 19 detected by the detection unit 18, before the opening and closing unit 16 is switched from an open state to a closed state. When the voltage, the frequency, and the phase in the first power grid 13 are substantially synchronized with the voltage, the frequency, and the phase in the second power grid 19, respectively, the charging and discharging apparatus 12 switches the opening and closing unit 16 from an open state to a closed state. In this manner, the charging and discharging apparatus 12 performs a transition control to synchronize a power state of the first power grid 13 with a power state of the second power grid 19, and then connects the first power grid 13 to the second power grid 19.

When performing the transition control, the charging and discharging apparatus 12 performs the control for the power supply control apparatus 14 not to supply the generated power of the power generation apparatus 15 to the first power grid 13. Specifically, the charging and discharging apparatus 12 raises the frequency of the power in the first power grid 13 to a predetermined first value. The power supply control apparatus 14 senses a system overfrequency by sensing that the frequency of the power in the first power grid 13 has reached a first value, and stops the supply of the generated power from the power generation apparatus 15 to the first power grid 13. In this manner, when performing the transition control, the charging and discharging apparatus 12 stops the supply of the generated power from the power generation apparatus 15 to the first power grid 13.

In a case where the supply of the generated power from the power generation apparatus 15 to the first power grid 13 is stopped, and then the generated power of the power generation apparatus 15 exceeds the power that is consumed by the power load 17, the charging and discharging apparatus 12 determines that the supply of the generated power from the power generation apparatus 15 to the first power grid 13 is resumed by the power supply control apparatus 14 being restarted. The charging and discharging apparatus 12 stores a resumption time, from a timing when the supply of the generated power from the power generation apparatus 15 to the first power grid 13 is stopped, to a timing when it is determined that the supply of the generated power from the power generation apparatus 15 to the first power grid 13 is resumed.

When performing the transition control, the charging and discharging apparatus 12 determines, based on the resumption time, a stop time that is a time interval for stopping the supply of the generated power to the first power grid 13. The charging and discharging apparatus 12 may determine, as the stop time, a time that is shorter than the resumption time by a predetermined value. While performing the transition control, the charging and discharging apparatus 12 raises the frequency of the power in the first power grid 13 to a predetermined first value, each time the stop time elapses, to stop the supply of the generated power from the power generation apparatus 15 to the first power grid 13. In this manner, it is possible to suppress instability of the power state of the first power grid 13 due to the power supply control apparatus 14 being restarted or the power generation apparatus 15 generating excessive power, when the transition control is performed, and failing of a synchronization control for synchronizing the power state of the first power grid 13 with the power state of the second power grid 19.

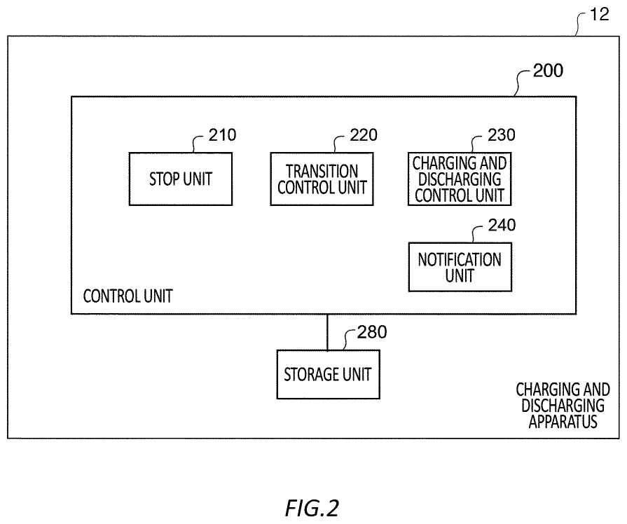

FIG. 2 shows an example of a system configuration related to a control function of the charging and discharging apparatus 12. The charging and discharging apparatus 12 includes a control unit 200 and a storage unit 280.

The control unit 200 is realized by an arithmetic processing device including a processor. The storage unit 280 is realized by including a non-volatile storage medium. The control unit 200 performs processing by using information stored in the storage unit 280. The control unit 200 may be implemented by a microcomputer including a CPU, a ROM, a RAM, an I/O, a bus, and the like. The charging and discharging apparatus 12 may be realized by including a computer.

In the present embodiment, the charging and discharging apparatus 12 is realized by a single apparatus. However, in another embodiment, the charging and discharging apparatus 12 may be realized by a plurality of apparatuses.

The control unit 200 includes a stop unit 210, a transition control unit 220, a charging and discharging control unit 230, and a notification unit 240.

The stop unit 210 stops the supply of the generated power, from the power generation apparatus 15 which is connected to the first power grid 13, to the first power grid 13. In a first state in which the power is not supplied from the second power grid 19 to the first power grid 13, the transition control unit 220 (i) causes the stop unit 210 to stop the supply of the generated power from the power generation apparatus 15 to the first power grid 13, when a first condition is satisfied, (ii) stores the resumption time, from when the supply of the generated power from the power generation apparatus 15 is stopped by the stop unit 210, to when the supply of the generated power from the power generation apparatus 15 is resumed, and (iii) performs the transition control to transition from the first state to a second state in which the power is able to be supplied from the second power grid 19 to the first power grid 13, based on the resumption time, when a second condition is satisfied. In this way, the transition control unit 220 performs the transition control from the first state to the second state, in consideration of the resumption time. This makes it possible to suppress a possibility that a problem occurs in the transition control due to an unexpected start of the supply of the generated power from the power generation apparatus 15 to the first power grid 13.

The power storage apparatus 11 is an example of a power storage apparatus which is connected to the first power grid 13. The charging and discharging control unit 230 controls the exchange of the power between the power storage apparatus 11 and the first power grid 13. For example, the charging and discharging control unit 230 controls a charging and discharging circuit included in the charging and discharging apparatus 12, thereby supplying, to the first power grid 13, the AC power generated by using the discharged power of the power storage apparatus 11. The charging and discharging control unit 230 charges the power storage apparatus 11 with the DC power generated by using the AC power received from the first power grid 13.

The first condition may include: a condition that a difference between an amount of the generated power of the power generation apparatus 15 and an amount of power consumption of the power load 17 which is connected to the first power grid 13 is greater than or equal to a predetermined value; or a condition that the difference between an amount of the generated power of the power generation apparatus 15 and an amount of power consumption of the power load 17 which is connected to the first power grid 13 is greater than or equal to a value that is determined based on a state of the power storage apparatus 11. The “state of the power storage apparatus 11” may be an amount of power storage and/or a deterioration state of the power storage apparatus 11. The first condition may include a condition that the amount of power storage in the power storage apparatus 11 which is connected to the first power grid 13 is greater than or equal to a predetermined value. The first condition may include a condition that at least one of the voltage, the frequency, or the phase of the first power grid 13, which is sensed by the charging and discharging apparatus 12, is abnormal.

The second condition may be a condition related to a state of the second power grid 19. The second condition may include a condition that a power state in the second power grid 19 is stable. For example, the second condition may include a condition that at least one of the voltage, the frequency, or the phase of the second power grid 19 is stable in time.

As at least a part of the transition control, the transition control unit 220 executes the synchronization control to synchronize, with the power state in the second power grid 19, the power state of the power that is supplied from the power storage apparatus 11, which is connected to the first power grid 13, to the first power grid 13. The transition control includes a control that is called an Active Synchronization.

The transition control unit 220 stops the synchronization control when a duration time of the synchronization control reaches a predetermined time (which may be referred to as the “stop time” in the present embodiment) that is determined based on the resumption time. The transition control unit 220 stops the synchronization control, and then resumes the synchronization control. Before resuming the synchronization control, the transition control unit 220 causes the stop unit 210 to execute the control to stop the supply of the generated power from the power generation apparatus 15 to the first power grid 13. This makes it possible to reduce a possibility of resuming the supply of the generated power from the power generation apparatus 15 to the first power grid 13 during the synchronization control.

By using the stored power of the power storage apparatus 11 to set the power state of the first power grid 13 to be a specific state, the stop unit 210 stops the supply of the generated power from the power generation apparatus 15 to the first power grid 13. Here, setting the power state of the first power grid 13 to be a specific state may include setting the frequency of the power of the first power grid 13 to be higher than or equal to a predetermined first value, and/or setting the frequency of the power of the first power grid 13 to be lower than or equal to a predetermined second value. The present embodiment described below will mainly describe an example in which the stop unit 210 stops the supply of the generated power from the power generation apparatus 15 to the first power grid 13 by setting the frequency of the power of the first power grid 13 to a predetermined first value (for example, 64 Hz). However, the present invention can adopt a mode in which the stop unit 210 stops the supply of the generated power from the power generation apparatus 15 to the first power grid 13 by setting the frequency of the power of the first power grid 13 to a predetermined second value (for example, 56 Hz) or lower.

The notification unit 240 provides a notification to a user associated with the power consumer. For example, when the processing related to the transition control fails, the notification unit 240 provides the notification to the user.

The charging and discharging apparatus 12 may function as a component of a HEMS. In this case, the stop unit 210, the transition control unit 220, the charging and discharging control unit 230, and the notification unit 240 may exchange various pieces of information related to the second power grid 19 and the first power grid 13, through a Home Energy Management System (HEMS) controller. The notification unit 240 may provide the notification to the user through the HEMS controller.

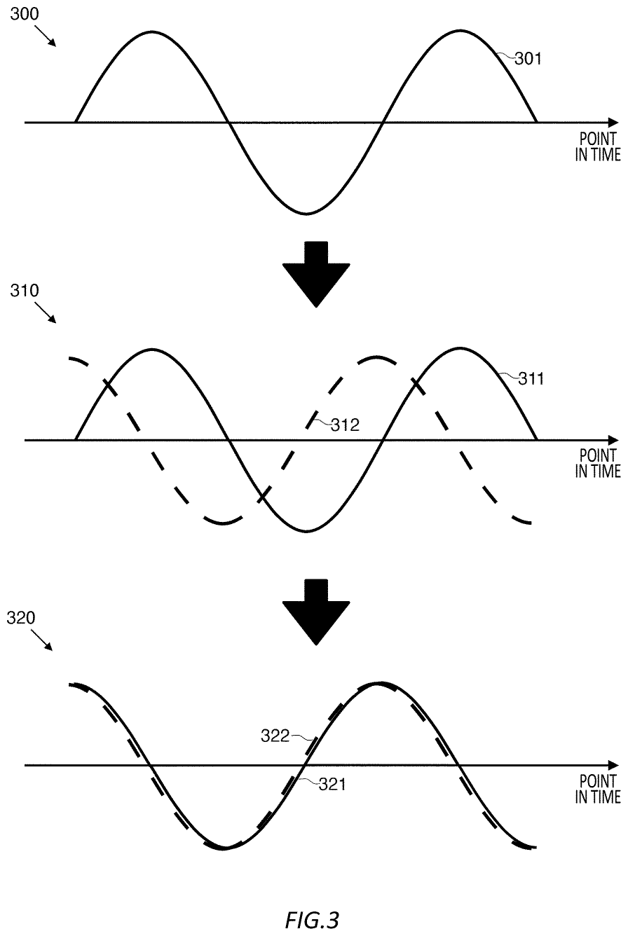

FIG. 3 is a conceptual diagram for describing a synchronization control that is included in a transition control performed by the transition control unit 220. A waveform diagram 300 shows a voltage waveform 301 that is output to the first power grid 13 by the charging and discharging apparatus 12 during an isolated operation at a time of a power outage.

A waveform diagram 310 shows a voltage waveform 311 that is output to the first power grid 13 by the charging and discharging apparatus 12, and a voltage waveform 312 of the second power grid 19, at a timing when the transition control unit 220 senses the restoration of the power to the second power grid 19 and starts the synchronization control. As shown by the voltage waveform 311 and the voltage waveform 312, when the isolated operation is performed, there can be a state in which the voltage that is output to the first power grid 13 by the charging and discharging apparatus 12, is different from the voltage in the second power grid 19, and the phase of the voltage that is output to the first power grid 13 by the charging and discharging apparatus 12 is different from the phase of the voltage in the second power grid 19. In addition, there can be a state in which the frequency that is output to the first power grid 13 by the charging and discharging apparatus 12 is different from the frequency in the second power grid 19.

A waveform diagram 320 shows a voltage waveform 321 that is output to the first power grid 13 by the charging and discharging apparatus 12, and a voltage waveform 322 of the second power grid 19, at a timing when the synchronization control is completed. As shown by the voltage waveform 321 and the voltage waveform 322, the transition control unit 220 substantially matches the voltage that is output to the first power grid 13 by the charging and discharging apparatus 12, with the voltage in the second power grid 19; substantially matches the phase of the voltage that is output to the first power grid 13 by the charging and discharging apparatus 12, with the phase of the voltage in the second power grid 19; and substantially matches the frequency of the voltage that is output to the first power grid 13 by the charging and discharging apparatus 12, with the frequency of the voltage in the second power grid 19. In this manner, the power state in the first power grid 13 is substantially synchronized with the power state in the second power grid 19.

In a state in which the power state in the first power grid 13 is substantially synchronized with the power state in the second power grid 19, the transition control unit 220 switches the opening and closing unit 16 from an open state to a closed state. In this manner, in the state in which the power state in the first power grid 13 is substantially synchronized with the power state in the second power grid 19, the first power grid 13 is connected to the second power grid 19. This makes it possible to start the grid-connected operation.

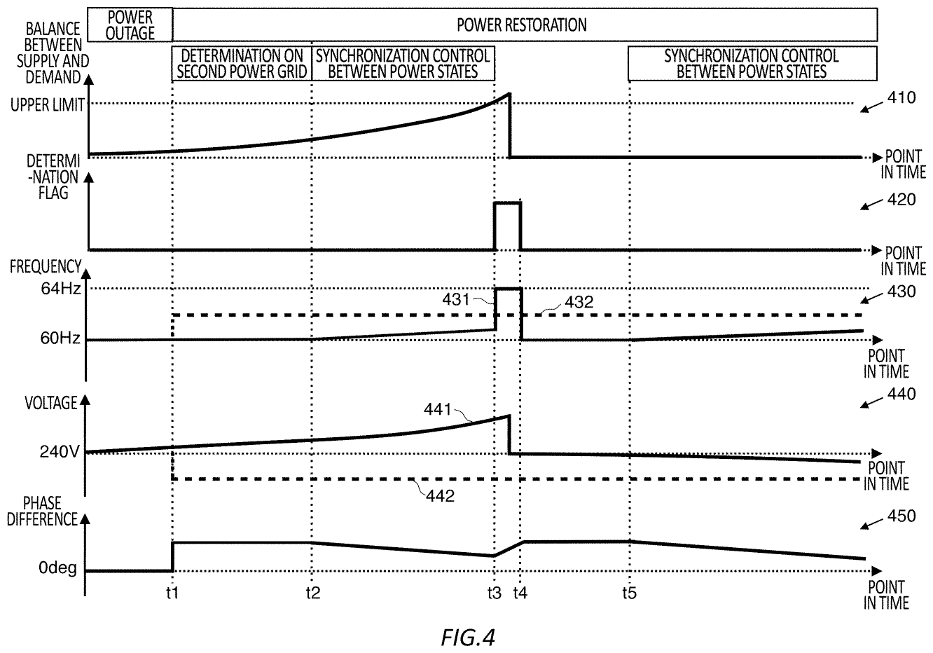

FIG. 4 is a diagram for describing a case in which generated power of the power generation apparatus 15 becomes excessive when the synchronization control is being executed between a power state of the first power grid 13 and a power state of the second power grid 19.

In FIG. 4, a graph 410 shows a time evolution of a balance between a supply and a demand of the power in the first power grid 13. Specifically, the graph 410 indicates a surplus or a deficiency of the generated power of the power generation apparatus 15 with respect to the power consumption of the power load 17. More specifically, the graph 410 shows surplus power of the generated power of the power generation apparatus 15 with respect to the power consumption of the power load 17. A graph 420 shows a flag indicating a determination result of the balance between the supply and the demand of the power in the first power grid 13. Specifically, the graph 420 indicates whether or not the generated power of the power generation apparatus 15 is determined to be excessive with respect to the power consumption of the power load 17. For example, a determination flag becomes a true value for a predetermined period of time, in a case where the generated power of the power generation apparatus 15 is excessive with respect to the power consumption of the power load 17; and becomes a false value, in a case where the generated power of the power generation apparatus 15 is not excessive with respect to the power consumption of the power load 17.

A graph 430 shows a waveform 431 of the frequency in the first power grid 13 and a waveform 432 of the frequency in the second power grid 19. A graph 440 shows a voltage waveform 441 in the first power grid 13, and a voltage waveform 442 in the second power grid 19. A graph 450 shows a phase difference of the voltage (which may be simply referred to as a “phase difference”) between the first power grid 13 and the second power grid 19.

At a point in time t1, the transition control unit 220 senses that the power is restored to the second power grid 19 from a power outage state. The transition control unit 220 may sense that the power is restored to the second power grid 19, based on the voltage, the frequency, and the phase of the second power grid 19 detected by the detection unit 18. The transition control unit 220 may sense that the power is restored to the second power grid 19, based on power restoration information that is notified from an outside.

When the power is sensed to be restored to the second power grid 19, the transition control unit 220 determines whether or not the power state of the second power grid 19 is stable. For example, the transition control unit 220 may determine whether or not the power state of the second power grid 19 is stable, based on an amount of change over time in the voltage, the frequency, and the phase of the second power grid 19 detected by the detection unit 18.

At a point in time t2, when the power state of the second power grid 19 is determined to be stable, the transition control unit 220 executes the synchronization control between the power state of the first power grid 13 and the power state of the second power grid 19. Specifically, the transition control unit 220 causes the charging and discharging control unit 230 to control the frequency in the first power grid 13 to approach the frequency in the second power grid 19. The transition control unit 220 further causes the charging and discharging control unit 230 to control the voltage in the first power grid 13 to approach the voltage in the second power grid 19. The transition control unit 220 further causes the charging and discharging control unit 230 to control the phase difference between the first power grid 13 and the second power grid 19 to approach zero.

Here, as shown in the graph 410, by the generated power of the power generation apparatus 15 being increased from the point in time t1, the difference between the generated power of the power generation apparatus 15 and the power consumption of the power load 17 is increased. This causes the voltage of the first power grid 13 to be increased, as well. The charging and discharging control unit 230 charges the power storage apparatus 11, with the surplus power of the generated power of the power generation apparatus 15 with respect to the power consumption of the power load 17.

When the surplus power reaches a predetermined upper limit value at a point in time t3, the determination flag becomes a true value for a predetermined period of time, in the stop unit 210. The upper limit value may be, for example, an upper limit value of the power at which the power storage apparatus 11 can be safely charged.

During the period of time in which the determination flag is a true value, the stop unit 210 increases the frequency of the power that is output to the first power grid 13 by the charging and discharging apparatus 12, to a predetermined frequency (for example, a frequency higher than a prescribed frequency). For example, the stop unit 210 increases, to 64 Hz, the frequency of the power that is output to the first power grid 13 by the charging and discharging apparatus 12. When the frequency of the power of the first power grid 13 is sensed to reach a predetermined frequency (for example, the system overfrequency), the power supply control apparatus 14 stops the supply of the generated power from the power generation apparatus 15 to the first power grid 13. In this manner, the synchronization control is stopped.

When a predetermined period of time elapses at a point in time t4, the determination flag becomes a false value, and the stop unit 210 returns, to a prescribed frequency of 60 Hz, the frequency that is output to the first power grid 13 by the charging and discharging apparatus 12. Then, at a point in time t5, the transition control unit 220 resumes the synchronization control of the power state.

As shown in FIG. 4, when the generated power of the power generation apparatus 15 becomes excessive with respect to the power consumption of the power load 17, the control is performed to stop the supply of the generated power from the power generation apparatus 15 to the first power grid 13, and the power state of the first power grid 13 is not stable. Further, in FIG. 4, in a case where the synchronization control is resumed at the point in time t5, and then the power supply control apparatus 14 is restarted, thereby resuming the supply of the generated power to the first power grid 13, the power state of the first power grid 13 can be unstable. This makes it difficult to synchronize the power state (for example, the voltage, the frequency, and the phase) of the first power grid 13, with the power state (for example, the voltage, the frequency, and the phase) of the second power grid 19. In this manner, the power restoration in the first power grid 13 becomes unstable.

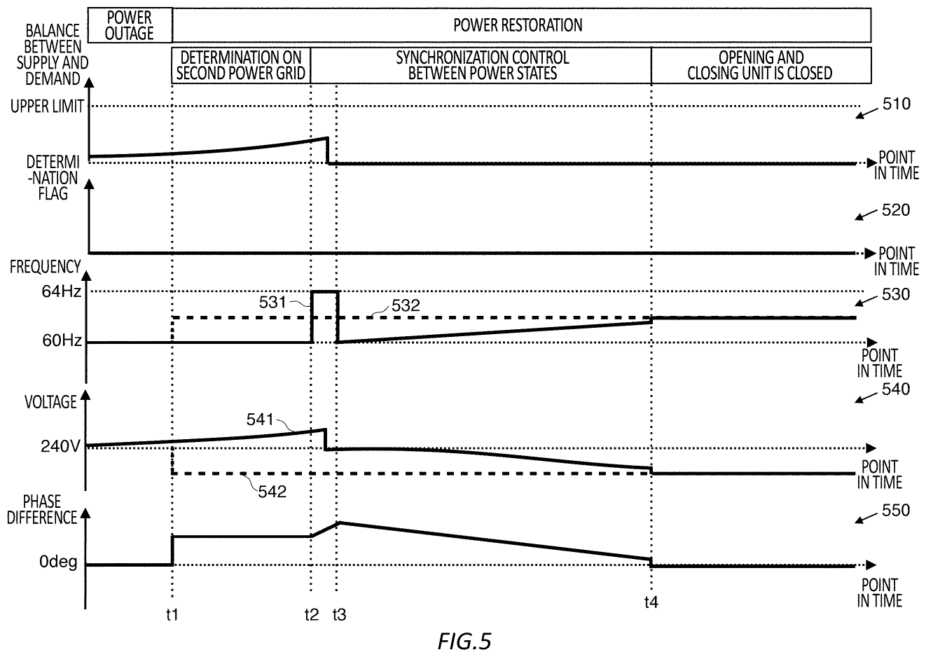

FIG. 5 is a diagram for describing a control for stopping a supply of the generated power of the power generation apparatus 15, when the synchronization control is performed between the power state of the first power grid 13 and the power state of the second power grid 19.

In FIG. 5, a graph 510 shows a time evolution of a balance between a supply and a demand of the power in the first power grid 13. A graph 520 shows a flag indicating a determination result of the balance between the supply and the demand of the power in the first power grid 13. A graph 530 shows a waveform 431 of the frequency in the first power grid 13 and a waveform 432 of the frequency in the second power grid 19. A graph 540 shows a voltage waveform 541 in the first power grid 13 and a voltage waveform 542 in the second power grid 19. A graph 550 shows a phase difference of the voltage between the first power grid 13 and the second power grid 19.

As in the case of FIG. 4, at the point in time t1, the transition control unit 220 senses that the power is restored to the second power grid 19 from a power outage state.

When the power is sensed to be restored to the second power grid 19 from a power outage state, the transition control unit 220 determines whether or not the power state of the second power grid 19 is stable.

At the point in time t2, when the power state of the second power grid 19 is determined to be stable, the transition control unit 220 causes the stop unit 210 to increases the frequency of the power that is output to the first power grid 13 by the charging and discharging apparatus 12, to a predetermined frequency (for example, a frequency higher than a prescribed frequency). For example, the stop unit 210 controls the charging and discharging control unit 230, thereby increasing, to 64 Hz, the frequency of the power that is output to the first power grid 13 by the charging and discharging apparatus 12. When the frequency of the power of the first power grid 13 is sensed to reach a predetermined frequency (the system overfrequency), the power supply control apparatus 14 stops the supply of the generated power from the power generation apparatus 15 to the first power grid 13.

At the point in time t3, when the stop unit 210 returns, to the prescribed frequency of 60 Hz, the frequency of the power that is output from the charging and discharging apparatus 12 to the first power grid 13, the transition control unit 220 starts the synchronization control between the power state of the first power grid 13 and the power state of the second power grid 19. Specifically, the transition control unit 220 causes the charging and discharging control unit 230 to control the frequency in the first power grid 13 to approach the frequency in the second power grid 19. The transition control unit 220 further causes the charging and discharging control unit 230 to control the voltage in the first power grid 13 to approach the voltage in the second power grid 19. The transition control unit 220 further causes the charging and discharging control unit 230 to control the phase difference between the first power grid 13 and the second power grid 19 to approach zero.

At the point in time t4, the transition control unit 220 closes the opening and closing unit 16, when it is determined that (i) the difference between the frequency in the first power grid 13 and the frequency in the second power grid 19 becomes smaller than a predetermined value, (ii) the difference between the voltage in the first power grid 13 and the voltage in the second power grid 19 becomes smaller than a predetermined value, and (iii) an absolute value of the phase difference between the first power grid 13 and the second power grid 19 becomes smaller than a predetermined value. In this manner, the first power grid 13 is connected to the second power grid 19.

In this way, the transition control unit 220 can perform the synchronization control, in a state in which the supply of the generated power from the power generation apparatus 15 to the first power grid 13 is stopped. This makes it possible to reduce the possibility that the generated power of the power generation apparatus 15 becomes excessive when the synchronization control is performed, and thus it is possible to restore the power in a state in which the power state of the first power grid 13 is stable.

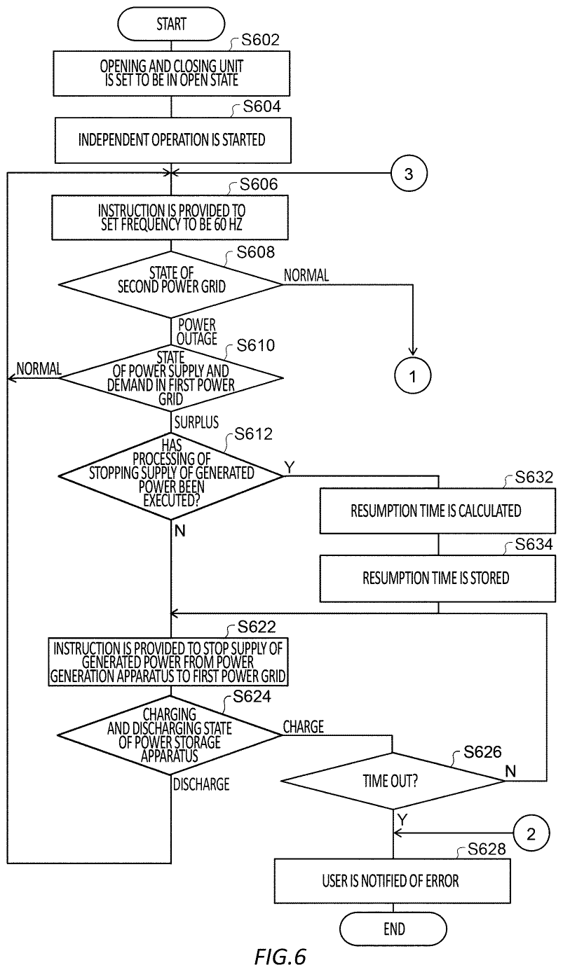

FIG. 6 shows a flowchart related to a control method that is executed in the system 5. The processing of the present flowchart is started when a power outage in the second power grid 19 is sensed.

In S602, the charging and discharging control unit 230 sets the opening and closing unit 16 to be in an open state. In this manner, the first power grid 13 is disconnected from the second power grid 19.

In S604, the independent operation is started in the system 5. Specifically, the charging and discharging control unit 230 uses the discharged power of the power storage apparatus 11 to generate the output voltage to the first power grid 13. The power supply control apparatus 14 is started by receiving the power supply from the charging and discharging apparatus 12; converts, into the AC power, the generated power of the power generation apparatus 15; and supplies the power to the first power grid 13 according to the voltage of the first power grid 13.

In S606, the charging and discharging control unit 230 instructs the charging and discharging circuit of the charging and discharging apparatus 12 to set the frequency that is output to the first power grid 13 by the charging and discharging apparatus 12, to be 60 Hz that is the prescribed frequency of the voltage in the power grid.

In S608, the transition control unit 220 determines the state of the second power grid 19. Specifically, the transition control unit 220 determines whether the second power grid 19 is in a power outage state or in a normal state. The transition control unit 220 determines whether the second power grid 19 is in a power outage state or in a normal state, based on the voltage, the frequency, and the phase that are detected by the detection unit 18.

The processing when it is determined in S608 that the second power grid 19 is in a normal state, will be described below. If it is determined in S608 that the second power grid 19 is in a power outage state, the transition control unit 220 determines a state of the power supply and demand in the first power grid 13, in S610. Specifically, the transition control unit 220 determines whether the first power grid 13 is in a power surplus state, or in a normal state in which there is no surplus power. For example, in a case of a state in which the power storage apparatus 11 is being charged with the power from the first power grid 13, the transition control unit 220 determines that the first power grid 13 is in a power surplus state. The state in which the power storage apparatus 11 is being charged with the power from the first power grid 13 means a state in which the power that is supplied from the power generation apparatus 15 to the first power grid 13 is greater than an amount of the power consumption of the power load 17. On the other hand, in a case of a state in which the charging and discharging apparatus 12 is supplying the power to the first power grid 13 by using the discharged power of the power storage apparatus 11, the transition control unit 220 determines that the first power grid 13 is in a normal state in which there is no surplus power. The state in which the charging and discharging apparatus 12 is supplying the power to the first power grid 13 by using the discharged power of the power storage apparatus 11 means a state that the power generation apparatus 15 is stopped, or the power that is supplied from the power generation apparatus 15 to the first power grid 13 is smaller than the power that is consumed by the power load 17.

If it is determined in S610 that the power in the first power grid 13 is in a normal state, the processing transitions to S606 by the transition control unit 220. If it is determined that the first power grid 13 is in a power surplus state, the transition control unit 220 determines in S612 whether or not the processing of stopping the supply of the generated power from the power generation apparatus 15 to the first power grid 13, has been executed.

If it is determined in S612 that the processing of stopping the supply of the generated power from the power generation apparatus 15 to the first power grid 13 has not been executed, the stop unit 210 provides, in S622, the instruction to stop the supply of the generated power from the power generation apparatus 15 to the first power grid 13. Specifically, the stop unit 210 sets the charging and discharging circuit of the charging and discharging apparatus 12 such that the frequency of the voltage that is output to the first power grid 13 by the charging and discharging apparatus 12, becomes a predetermined value. For example, the stop unit 210 sets the charging and discharging circuit of the charging and discharging apparatus 12 such that the frequency of the voltage that is output to the first power grid 13 by the charging and discharging apparatus 12, becomes 64 Hz. Here, the transition control unit 220 stores a point in time when the instruction is provided to stop the supply of the generated power from the power generation apparatus 15 to the first power grid 13.

In S624, the transition control unit 220 determines a charging and discharging state of the power storage apparatus 11. Specifically, the transition control unit 220 determines whether the state is that the power storage apparatus 11 is being charged with the power of the first power grid 13, or the state is that the charging and discharging apparatus 12 is supplying the power to the first power grid 13 by using the discharged power of the power storage apparatus 11. The state in which the power storage apparatus 11 is being charged with the power of the first power grid 13 means a state in which the supply of the generated power from the power generation apparatus 15 to the first power grid 13 is not stopped; and the state in which the charging and discharging apparatus 12 is supplying the power to the first power grid 13 by using the discharged power of the power storage apparatus 11 means a state in which the supply of the generated power from the power generation apparatus 15 to the first power grid 13 is stopped.

When it is determined in S624 that the state is that the charging and discharging apparatus 12 is supplying the power to the first power grid 13 by using the discharged power of the power storage apparatus 11, the processing transitions to S606. At this time, the transition control unit 220 stores the current point in time. The current point in time stored by the transition control unit 220 is used to calculate the resumption time in S632.

If it is determined in S624 that the power storage apparatus 11 is in a state of being charged with the power of the first power grid 13, the transition control unit 220 determines in S626 whether or not the processing of stopping the supply of the generated power from the power generation apparatus 15 to the first power grid 13, has timed out. Specifically, the transition control unit 220 determines whether or not the elapsed time from the point in time when the processing of stopping the supply of the generated power from the power generation apparatus 15 to the first power grid 13 is started in S622, to the current point in time, exceeds a predetermined time.

If it is determined in S626 that the processing of stopping the supply of the generated power from the power generation apparatus 15 to the first power grid 13 has timed out, the notification unit 240 notifies, in S628, the user associated with the power consumer that an error has occurred; and the processing of the present flowchart ends. If it is determined in S626 that the processing of stopping the supply of the generated power from the power generation apparatus 15 to the first power grid 13 has not timed out, the processing transitions to S622.

If it is determined in S612 that the processing of stopping the supply of the generated power from the power generation apparatus 15 to the first power grid 13 has been executed, the transition control unit 220 calculates the resumption time in S632. The resumption time is the elapsed time from the point in time which is stored by the transition control unit 220 in S624 and at which it is determined that the state is that the charging and discharging apparatus 12 is supplying the power to the first power grid 13 by using the discharged power of the power storage apparatus 11, to the point in time when it is determined in S610 that the first power grid 13 is in a power surplus state.

The point in time stored by the transition control unit 220 in S624 can be considered to be the point in time when the supply of the generated power from the power generation apparatus 15 to the first power grid 13 is stopped; and the point in time when it is determined in S610 that the first power grid 13 is in a power surplus state can be considered to be the point in time when the supply of the generated power from the power generation apparatus 15 to the first power grid 13 is performed. Therefore, the elapsed time from the point in time stored by the transition control unit 220 in S624, to the point in time when it is determined in S610 that the first power grid 13 is in a power surplus state, can be considered to be the resumption time from when the supply of the generated power from the power storage apparatus 11 to the first power grid 13 is stopped to when the supply of the generated power from the power storage apparatus 11 to the first power grid 13 is resumed.

In S634, the transition control unit 220 stores the resumption time, and the processing transitions to S622. Here, when the resumption time calculated in S632 is shorter than the resumption time already stored, the transition control unit 220 may update the resumption time stored by storing the resumption time calculated in S632. When the resumption time calculated in S632 is greater than or equal to the previously stored resumption time, the previously stored resumption time may be maintained without the resumption time calculated in S632 being stored. Under a condition that a situation in which the resumption time calculated in S632 is shorter than the already stored resumption time, occurs multiple times, the transition control unit 220 may update the resumption time stored by storing the resumption time calculated in S632. The resumption time stored in S634 is used in a case of performing the synchronization control of the power states between the first power grid 13 and the second power grid 19.

As described in relation to S610, S622, S624, and the like, in the first state in which the power is not supplied from the second power grid 19 to the first power grid 13, the transition control unit 220 causes the stop unit 210 to stop the supply of the generated power from the power generation apparatus 15 to the first power grid 13, when a condition that (i) the difference between an amount of the generated power of the power generation apparatus 15 and an amount of power consumption of the power load 17 which is connected to the first power grid 13 is greater than or equal to a predetermined value, is satisfied. The “predetermined value” is, for example, a value that exceeds zero. The “predetermined value” may be determined based on the state of the power storage apparatus 11. The “predetermined value” may be determined based on an amount of power storage and/or a deterioration state of the power storage apparatus 11. The “predetermined value” may be determined to be a smaller value as the amount of power storage in the power storage apparatus 11 is increased. The “predetermined value” may be determined to be a smaller value as a deterioration degree of the power storage apparatus 11 is increased. As described in relation to S632, S634, and the like, the transition control unit 220 (ii) stores the resumption time, from when the supply of the generated power from the power generation apparatus 15 is stopped by the stop unit 210, to when the supply of the generated power from the power generation apparatus 15 is resumed.

The condition that the difference between an amount of the generated power of the power generation apparatus 15 and an amount of power consumption of the power load 17 which is connected to the first power grid 13 is greater than or equal to a predetermined value, is an example of the first condition. The first condition may include a condition that an amount of power storage in the power storage apparatus 11 which is connected to the first power grid 13 is greater than or equal to a predetermined value. For example, the processing from S612 onward may be executed under a further condition that the amount of power storage in the power storage apparatus 11 which is connected to the first power grid 13 is greater than or equal to a predetermined value. The first condition may include a condition that at least one of the voltage, the frequency, or the phase of the first power grid 13 is abnormal. For example, the processing from S612 onward may be executed under a further condition that at least one of the voltage, the frequency, or the phase of the first power grid 13 is determined to be abnormal based on a predetermined determination condition.

According to the processing of the flowchart shown in FIG. 6, while the second power grid 19 is in a power outage state and the independent operation is performed in the system 5, each time the supply of the generated power from the power generation apparatus 15 to the first power grid 13 is started, the transition control unit 220 stops, through the stop unit 210, the supply of the generated power from the power generation apparatus 15 to the first power grid 13. When the supply of the generated power from the power generation apparatus 15 to the first power grid 13 is started, the transition control unit 220 calculates the resumption time, from when the supply of the generated power from the power generation apparatus 15 to the first power grid 13 is stopped, to when the supply of the generated power from the power generation apparatus 15 to the first power grid 13 is started. This makes it possible to actually measure the time when the supply of the generated power from the power generation apparatus 15 to the first power grid 13 is resumed.

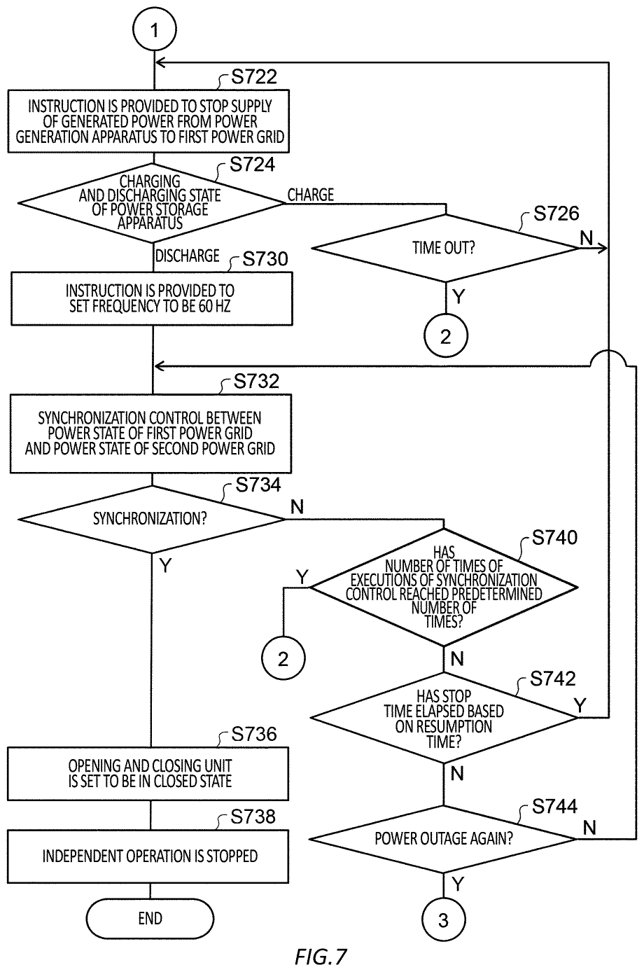

FIG. 7 is a flowchart related to processing when the second power grid 19 is determined to be in a normal state in S608 of FIG. 6. If it is determined in S608 of FIG. 6 that the second power grid 19 is in a normal state, the stop unit 210 controls, in S722, the charging and discharging control unit 230 to provide an instruction to stop the supply of the generated power from the power generation apparatus 15 to the first power grid 13. Specifically, the stop unit 210 sets the charging and discharging circuit of the charging and discharging apparatus 12 such that the frequency of the voltage that is output to the first power grid 13 by the charging and discharging apparatus 12, becomes a predetermined value. For example, the stop unit 210 sets the charging and discharging circuit of the charging and discharging apparatus 12 such that the frequency of the voltage that is output to the first power grid 13 by the charging and discharging apparatus 12, becomes 64 Hz. Here, the transition control unit 220 stores a point in time when the stop unit 210 stops the supply of the generated power from the power generation apparatus 15 to the first power grid 13.

In S724, the transition control unit 220 determines the charging and discharging state of the power storage apparatus 11. Specifically, the transition control unit 220 determines whether the state is that the power storage apparatus 11 is being charged with the power of the first power grid 13, or the state is that the charging and discharging apparatus 12 is supplying the power to the first power grid 13 by using the discharged power of the power storage apparatus 11. As described above, the state in which the power storage apparatus 11 is being charged with the power of the first power grid 13 means a state in which the supply of the generated power from the power generation apparatus 15 to the first power grid 13 is not stopped; and the state in which the charging and discharging apparatus 12 is supplying the power to the first power grid 13 by using the discharged power of the power storage apparatus 11 means a state in which the supply of the generated power from the power generation apparatus 15 to the first power grid 13 is stopped.

When it is determined in S724 that the state is that the charging and discharging apparatus 12 is supplying the power to the first power grid 13 by using the discharged power of the power storage apparatus 11, the processing transitions to S730. At this time, the transition control unit 220 stores the current point in time. The current point in time stored by the transition control unit 220 is used in the processing of S742.

In S730, the transition control unit 220 instructs, through the charging and discharging control unit 230, the charging and discharging circuit of the charging and discharging apparatus 12 to set the frequency that is output to the first power grid 13 by the charging and discharging apparatus 12, to be 60 Hz that is the prescribed frequency of the voltage in the power grid.

Subsequently in S732, the transition control unit 220 executes the synchronization control between the power state of the first power grid 13 and the power state of the second power grid 19. Specifically, the transition control unit 220 adjusts, through the charging and discharging control unit 230, the power that is output to the first power grid 13 by the discharged power of the power storage apparatus 11 such that the voltage, the frequency, and the phase in the first power grid 13 substantially match the voltage, the frequency, and the phase of the second power grid 19.

In S734, the transition control unit 220 determines whether or not the power state of the first power grid 13 is synchronized with the power state of the second power grid 19. Specifically, the transition control unit 220 determines that the power state of the first power grid 13 is synchronized with the power state of the second power grid 19, when (i) the difference between the frequency in the first power grid 13 and the frequency in the second power grid 19 becomes smaller than a predetermined value, (ii) the difference between the voltage in the first power grid 13 and the voltage in the second power grid 19 becomes smaller than a predetermined value, and (iii) an absolute value of the phase difference between the first power grid 13 and the second power grid 19 becomes smaller than a predetermined value.

If it is determined in S734 that the power state of the first power grid 13 is synchronized with the power state of the second power grid 19, the transition control unit 220 sets, in S736, the opening and closing unit 16 to be in a closed state, and stops, in S738, the independent operation in the system 5. In this manner, the first power grid 13 is connected to the second power grid 19, and the grid-connected operation is started.

If it is determined in S734 that the power state of the first power grid 13 is not synchronized with the power state of the second power grid 19, the transition control unit 220 determines in S740 whether or not the number of times of executions of the synchronization control in S732 reaches a predetermined number of times. If it is determined in S740 that the number of times of executions of the synchronization control has reached a predetermined number of times, the processing transitions to S628 in the flowchart of FIG. 6.

If it is determined in S740 that the number of times of executions of the synchronization control has not reached a predetermined number of times, the transition control unit 220 determines whether or not a stop time elapses since the point in time when it is determined in S724 that the state is that the charging and discharging apparatus 12 is supplying the power to the first power grid 13 by using the discharged power of the power storage apparatus 11. The stop time is determined based on the resumption time stored in S634. Specifically, the transition control unit 220 may determine, as the stop time, a time that is shorter than the resumption time by a predetermined time.

If it is determined in S742 that a stop time has elapsed, the processing transitions to S722. This makes it possible to cause the power supply control apparatus 14 not to resume the supply of the generated power from the power generation apparatus 15 to the first power grid 13, when the synchronization control is being performed. When it is determined in S742 that the stop time has not elapsed, the transition control unit 220 determines in S744 whether or not the second power grid 19 is in a power outage state again. If it is determined that the second power grid 19 is in a power outage state again, the processing transitions to S606 in the flowchart of FIG. 6. If it is determined that the second power grid 19 is not in a power outage state again, the processing transitions to S732, and the transition control unit 220 newly starts executing the synchronization control.

If it is determined in S724 that the power storage apparatus 11 is in a state of being charged with the power of the first power grid 13, the transition control unit 220 determines in S726 whether or not the processing of stopping the supply of the generated power from the power generation apparatus 15 to the first power grid 13, has timed out. Specifically, the transition control unit 220 determines whether or not the elapsed time from the point in time when the processing of stopping the supply of the generated power from the power generation apparatus 15 to the first power grid 13 is started in S722, to the current point in time, exceeds a predetermined time.

If it is determined in S726 that the processing of stopping the supply of the generated power from the power generation apparatus 15 to the first power grid 13 has timed out, the processing transitions to S628 in the flowchart of FIG. 6. If it is determined in S726 that the processing of stopping the supply of the generated power from the power generation apparatus 15 to the first power grid 13 has not timed out, the processing transitions to S722.

As described in relation to the processing from S608 to S742 in FIG. 6, when the condition that the power state in the second power grid 19 is stable is satisfied, the transition control unit 220 performs, based on the resumption time, the transition control of the transition from the first state to the second state in which the power supply from the second power grid 19 to the first power grid 13 is possible. Specifically, as at least a part of the transition control, the transition control unit 220 executes the synchronization control to synchronize, with the power state in the second power grid 19, the power state of the power that is supplied, from the power storage apparatus 11 which is connected to the first power grid 13, to the first power grid 13. Here, the condition that the power state in the second power grid 19 is stable is an example of the second condition related to the state of the second power grid 19.

As described in relation to S632, S634, S722, S732, S742, and the like, the transition control unit 220 stops the synchronization control when a duration time of the synchronization control reaches a predetermined time that is determined based on the resumption time. Further, in a case of stopping the synchronization control and then resuming the synchronization control, the transition control unit 220 causes, before resuming the synchronization control, the stop unit 210 to execute the control to stop the supply of the generated power from the power generation apparatus 15 to the first power grid 13. This makes it possible to reduce a possibility that a problem occurs in the transition control due to an unexpected resumption of the supply of the generated power from the power generation apparatus 15 to the first power grid 13 during the synchronization control.

As described in relation to S622, S722, and the like, the stop unit 210 stops the supply of the generated power from the power generation apparatus 15 to the first power grid 13, by using the stored power of the power storage apparatus 11 to set the power state of the first power grid 13 to be a specific state. Specifically, the stop unit 210 stops the supply of the generated power from the power generation apparatus 15 to the first power grid 13, by setting the frequency of the power of the first power grid 13 to be higher than or equal to a predetermined first value (for example, 64 Hz). In this manner, even when it is not possible to stop the operation of the power supply control apparatus 14 through the communication or the like, it is possible to stop the operation of the power supply control apparatus 14 by setting the power state of the first power grid 13 to a specific state.

As another embodiment, the present invention may adopt a mode in which when the power supply control apparatus 14 has a function of stopping the supply of the generated power from the power generation apparatus 15 to the first power grid 13 based on a magnitude of the voltage of the first power grid 13, the stop unit 210 stops the supply of the generated power from the power generation apparatus 15 to the first power grid 13, by setting the voltage of the first power grid 13 to be higher than or equal to a predetermined first voltage value, and/or by setting the voltage of the first power grid 13 to be lower than or equal to a predetermined second voltage value.

As described above, with the system 5, the transition control unit 220 can measure the resumption time, from when the power supply control apparatus 14 is stopped, to when the power supply control apparatus 14 is restarted, during the isolated operation. Further, it is possible to perform the synchronization control between the power state of the first power grid 13 and the power state of the second power grid 19, in consideration of the resumption time. This makes it possible to suppress a possibility of an unexpected start of the supply of the generated power from the power generation apparatus 15 to the first power grid 13. Furthermore, it is possible to suppress a possibility that a problem occurs in the synchronization control.

In the present embodiment, the power storage apparatus 11 is a power storage apparatus which is mounted on the vehicle 10. In another embodiment, the power storage apparatus 11 may be a power storage apparatus which is not mounted on the vehicle 10. For example, in another embodiment, the power storage apparatus 11 may be a stationary battery. The power storage apparatus 11 is an example of a power source which is connected to the first power grid 13 and is able to supply the power to the first power grid 13. An example of the power source can include a fuel cell, an internal combustion engine, a flywheel battery, or the like. The power storage apparatus 11 is an example of a power absorption apparatus which is connected to the first power grid 13 and is able to absorb the power from the first power grid 13. For example, the power absorption apparatus may be a power storage apparatus which converts the power of the first power grid 13 into rotational kinetic energy and stores it. The power absorption apparatus is not necessarily limited to a power storage apparatus, and may include an apparatus which absorbs the surplus power of the first power grid 13 and releases it as thermal energy or the like.

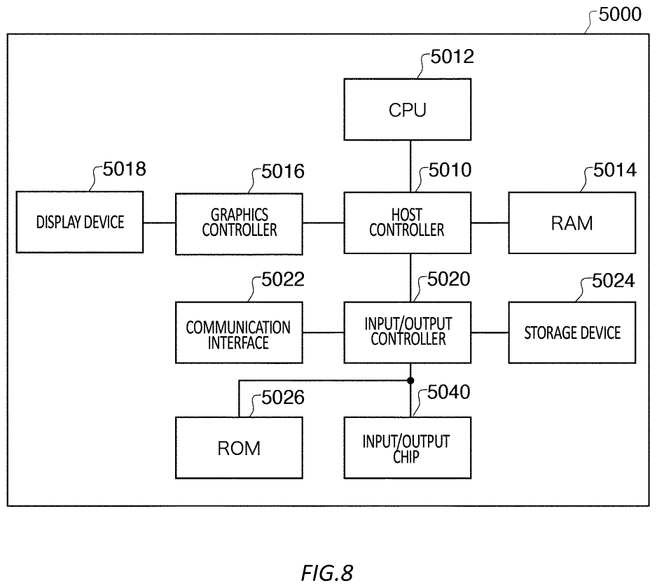

FIG. 8 shows an example of a computer 5000 in which a plurality of embodiments of the present invention can be entirely or partially embodied. A program installed on the computer 5000 can cause the computer 5000 to function as the system 5 according to the embodiment or each unit of the system, or the charging and discharging apparatus 12 or each unit of the apparatus, to perform operations associated with the system or each unit of the system or the apparatus or each unit of the apparatus, and/or to perform a process or steps of the process according to the embodiment. Such a program may be executed by a CPU 5012 in order to cause the computer 5000 to execute a specific operation associated with some or all of the processing procedures and the blocks in the block diagrams described herein.

The computer 5000 according to the present embodiment includes the CPU 5012 and a RAM 5014, which are mutually connected by a host controller 5010. The computer 5000 also includes a ROM 5026, a storage device 5024, a communication interface 5022, and an input/output chip 5040. The ROM 5026, the storage device 5024, the communication interface 5022, and the input/output chip 5040 are connected to the host controller 5010 via an input/output controller 5020.

The CPU 5012 operates in accordance with the programs stored in the ROM 5026 and the RAM 5014, thereby controlling each unit. A graphics controller 5016 obtains image data generated by the CPU 5012 on a frame buffer or the like provided in the RAM 5014 or in itself, and causes the image data to be displayed on a display device 5018.

The communication interface 5022 communicates with other electronic devices via a network. The storage device 5024 stores a program and data used by the CPU 5012 in the computer 5000. The program and/or the data are read from a computer-readable storage medium, such as a CD-ROM, DVD-ROM, or memory card, and are provided to the storage device 5024.

The ROM 5026 stores a boot program or the like that is executed by the computer 5000 during activation, and/or a program that depends on hardware of the computer 5000. The input/output chip 5040 may also connect various input/output units such as a keyboard, a mouse, and a monitor, to the input/output controller 5020 via input/output ports such as a serial port, a parallel port, a keyboard port, a mouse port, a monitor port, a USB port, a HDMI (registered trademark) port.

A program is provided via a network or a computer-readable storage medium such as a CD-ROM, A DVD-ROM, or a memory card. The RAM 5014, the ROM 5026, or the storage device 5024 may be an example of the computer-readable storage medium. The program is installed in the storage device 5024, the RAM 5014, or the ROM 5026, and is executed by the CPU 5012. Information processing written in these programs is read by the computer 5000, and provides cooperation between the programs and the various types of hardware resources described above. An apparatus or a method may be constituted by implementing an operation or processing of information in accordance with the use of the computer 5000.

For example, when a communication is executed between the computer 5000 and an external device, the CPU 5012 may execute a communication program loaded on the RAM 5014, and instruct the communication interface 5022 to execute communication processing based on processing written in the communication program. Under the control of the CPU 5012, the communication interface 5022 reads transmission data stored in a transmission buffer processing region provided in a recording medium such as the RAM 5014 or the storage device 5024, transmits the read transmission data to the network, and writes reception data received from the network into a reception buffer processing region or the like provided on the recording medium.

The CPU 5012 may cause all or a necessary portion of a file or a database to be read into the RAM 5014, the file or the database having been stored in the recording medium such as the storage device 5024 or the like, and perform various types of processing on the data on the RAM 5014. Next, the CPU 5012 writes back the processed data into the recording medium.

Various types of information such as various types of programs, data, a table, and a database may be stored in the recording medium, and may be subjected to information processing. The CPU 5012 may execute, on the data read from the RAM 5014, various types of processing including various kinds of operations, information processing, conditional judgement, conditional branching, unconditional branching, information retrieval/replacement, or the like described herein and specified by instruction sequences of the programs, and write back a result into the RAM 5014. In addition, the CPU 5012 may retrieve information in a file, a database, or the like in the recording medium. For example, when a plurality of entries each having an attribute value of a first attribute associated with an attribute value of a second attribute, are stored in the recording medium, the CPU 5012 may retrieve an entry having a designated attribute value of the first attribute that matches a condition from among the plurality of entries, and read the attribute value of the second attribute stored in this entry, thereby obtaining the attribute value of the second attribute associated with the first attribute that satisfies a predetermined condition.

The programs or software modules described above may be stored in the computer-readable storage medium on the computer 5000 or in the vicinity of the computer 5000. A recording medium such as a hard disk or a RAM provided in a server system connected to a dedicated network or the Internet can be used as the computer-readable storage medium. The program stored in the computer-readable storage medium may be provided to the computer 5000 via a network.

A program, which is installed on a computer 5000 and causes the computer 5000 to function as the charging and discharging apparatus 12, may work on the CPU 5012 or the like to cause the computer 5000 to function as each unit of the charging and discharging apparatus 12, when executed by the computer. By the information processing described in these programs being read by the computer 5000, the computer 5000 functions as each unit of the charging and discharging apparatus 12 that is specific means as a result of the software and the above-described various types of hardware resources cooperating with each other. Then, by realizing computation or processing of information in accordance with the intended use of the computer 5000 in the present embodiment by the specific means, the unique charging and discharging apparatus 12 in accordance with the intended use is constructed.

Various embodiments have been described with reference to the flowchart, the configuration diagram, or the like. Blocks in the flowchart or the configuration diagram may respectively represent (1) steps of processes in which operations are performed or (2) “units” of apparatuses responsible for performing operations. A specific step and each unit may be implemented by a dedicated circuit, a programmable circuit supplied with computer-readable instructions stored on a computer-readable storage medium, and/or a processor supplied with computer-readable instructions stored on a computer-readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element or the like such as a flip-flop, a register, a field programmable gate array (FPGA), a programmable logic array (PLA), or the like.

The computer-readable storage medium may include any tangible device capable of storing instructions to be executed by an appropriate device, and as a result, the computer-readable storage medium having instructions stored therein constitutes at least a part of a product including instructions which can be executed to provide means for executing processing procedures or operations specified in the block diagrams. An example of the computer-readable storage medium may include an electronic storage medium, a magnetic storage medium, an optical storage medium, an electromagnetic storage medium, a semiconductor storage medium, etc. A more specific example of the computer-readable storage medium may include a floppy (registered trademark) disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a compact disc read-only memory (CD-ROM), a digital versatile disc (DVD), a Blu-ray (registered trademark) disc, a memory stick, an integrated circuit card, or the like.

The computer-readable instructions may include an assembler instruction, an instruction-set-architecture (ISA) instruction, a machine instruction, a machine-dependent instruction, a microcode, a firmware instruction, state-setting data, or either of source code or object code written in any combination of one or more programming languages including an object-oriented programming language such as Smalltalk (registered trademark), JAVA (registered trademark), and C++, or the like, and a conventional procedural programming language such as a “C” programming language or a similar programming language.

Computer-readable instructions may be provided to a processor of programmable data processing device of a computer or the like, or to a programmable circuit, locally or via a local area network (LAN), wide area network (WAN) such as the Internet, etc., so that the computer-readable instructions is executed to create means for performing operations specified in the described processing procedures or block diagrams.

Here, the computer may be a computer such as a PC (personal computer), a tablet computer, smartphone, a work station, a server computer, or a general purpose computer, or may be a computer system in which a plurality of computers are connected. Such computer system to which the plurality of computers are connected is also referred to as a distributed computing system, and is a computer in a broad sense. In the distributed computing system, the plurality of computers collectively execute a program, by each of the plurality of computers executing a portion of the program, and passing the data during the execution of the program between the computers as necessary.

Examples of the processor include a computer processor, a central processing unit (CPU), a processing unit, a microprocessor, a digital signal processor, a controller, a microcontroller, and the like. The computer may include one processor or a plurality of processors. In a multi-processor system including a plurality of processors, the plurality of processors collectively execute a program, by each of the processors executing a portion of the program, and passing the data during the execution of the program between the processors as necessary. For example, in execution of multiple tasks, each of the plurality of processors may execute a portion of each task pieces by pieces by performing task-switching for each time slice. In this case, which portion of one program each processor is responsible for executing dynamically changes. In addition, which portion of the program each of the plurality of processors is to execute may be statically determined by multi-processor aware programming.

While the present invention has been described by way of the embodiments, the technical scope of the present invention is not limited to the above-described embodiments. It is apparent to persons skilled in the art that various alterations or improvements can be made to the above described embodiments. It is also apparent from description of the claims that the embodiments to which such changes or improvements are made may be included in the technical scope of the present invention.

The operations, procedures, steps, and stages etc. of each process performed by a device, system, program, and method shown in the claims, specification, or diagrams can be executed in any order as long as the order is not indicated by “before”, “prior to”, or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

5: system; 10: vehicle; 11: power storage apparatus; 12: charging and discharging apparatus; 13: first power grid; 14: power supply control apparatus; 15: power generation apparatus; 16: opening and closing unit; 17: power load; 18: detection unit; 19: second power grid; 200: control unit; 210: stop unit; 220: transition control unit; 230: charging and discharging control unit; 240: notification unit; 280: storage unit; 300, 310, 320: waveform diagram; 301, 311, 312, 321, 322: voltage waveform; 410, 420, 430, 440, 450: graph; 431, 432: waveform; 441, 442: voltage waveform; 510, 520, 530, 540, 550: graph; 541, 542: voltage waveform; 5000: computer; 5010: host controller; 5012: CPU; 5014: RAM; 5016: graphics controller; 5018: display device; 5020: input/output controller; 5022: communication interface; 5024: storage device; 5026: ROM; 5040: input/output chip.

1. A system which controls a power grid, the system comprising:
a stop unit which stops a supply of generated power, from a power generation apparatus which is connected to the power grid, to the power grid; and
a transition control unit which in a first state in which power is not supplied from another power grid to the power grid,
causes the stop unit to stop the supply of the generated power from the power generation apparatus to the power grid, when a first condition is satisfied,
stores a resumption time, from when the supply of the generated power from the power generation apparatus is stopped by the stop unit, to when the supply of the generated power from the power generation apparatus is resumed, and
performs a transition control to transition from the first state to a second state in which the power is able to be supplied from the another power grid to the power grid, based on the resumption time, when a second condition is satisfied.

2. The system according to claim 1 further comprising:
a charging and discharging control unit which controls an exchange of power between a power storage apparatus which is connected to the power grid and the power grid.

3. The system according to claim 1, wherein
the first condition includes
a condition that a difference between an amount of the generated power of the power generation apparatus and an amount of power consumption of a power load which is connected to the power grid is greater than or equal to a predetermined value; or
a condition that the difference between an amount of the generated power of the power generation apparatus and an amount of power consumption of a power load which is connected to the power grid is greater than or equal to a value that is determined based on a state of a power storage apparatus which is connected to the power grid.

4. The system according to claim 2, wherein
the first condition includes a condition that an amount of power storage in the power storage apparatus is greater than or equal to a predetermined value.

5. The system according to claim 1, wherein
the second condition is a condition related to a state of the another power grid.

6. The system according to claim 1, wherein
the second condition includes a condition that a power state in the another power grid is stable.

7. The system according to claim 1, wherein
as at least a part of the transition control, the transition control unit executes a synchronization control to synchronize, with a power state in the another power grid, a power state of power that is supplied, from a power storage apparatus which is connected to the power grid, to the power grid.

8. The system according to claim 7, wherein
the transition control unit stops the synchronization control when a duration time of the synchronization control reaches a predetermined time that is determined based on the resumption time.

9. The system according to claim 8, wherein
the transition control unit stops the synchronization control, and then resumes the synchronization control.

10. The system according to claim 9, wherein
before resuming the synchronization control, the transition control unit causes the stop unit to execute a control to stop the supply of the generated power from the power generation apparatus to the power grid.

11. The system according to claim 1, wherein
by using stored power of a power storage apparatus which is connected to the power grid, to set a power state of the power grid to be a specific state, the stop unit stops the supply of the generated power from the power generation apparatus to the power grid.

12. The system according to claim 11, wherein
setting the power state of the power grid to be a specific state includes setting a frequency of the power of the power grid to be higher than or equal to a predetermined first value, and/or setting a frequency of the power of the power grid to be lower than or equal to a predetermined second value.

13. The system according to claim 2, wherein
the power storage apparatus is mounted on a vehicle.

14. The system according to claim 2, wherein
the first condition includes
a condition that a difference between an amount of the generated power of the power generation apparatus and an amount of power consumption of a power load which is connected to the power grid is greater than or equal to a predetermined value; or
a condition that the difference between an amount of the generated power of the power generation apparatus and an amount of power consumption of a power load which is connected to the power grid is greater than or equal to a value that is determined based on a state of the power storage apparatus.

15. The system according to claim 2, wherein
the first condition includes a condition that an amount of power storage in the power storage apparatus is greater than or equal to a predetermined value.

16. The system according to claim 2, wherein
the second condition is a condition related to a state of the another power grid.

17. The system according to claim 2, wherein
the second condition includes a condition that a power supply from the another power grid is stable.

18. The system according to claim 2, wherein
as at least a part of the transition control, the transition control unit executes a synchronization control to synchronize, with a power state in the another power grid, a power state of power that is supplied, from the power storage apparatus, to the power grid.

19. A control method for a power grid, the control method comprising:
in a first state in which power is not supplied from another power grid to the power grid,
stopping a supply of generated power, from a power generation apparatus which is connected to the power grid, to the power grid, when a first condition is satisfied;
storing a resumption time, from when the supply of the generated power from the power generation apparatus is stopped, to when the supply of the generated power from the power generation apparatus is resumed; and
performing a transition control to transition from the first state to a second state in which the power is able to be supplied from the another power grid to the power grid, based on the resumption time, when a second condition is satisfied.

20. A non-transitory computer-readable storage medium having stored thereon a program that, when executed by a computer, causes the computer to function as:
a stop unit which stops a supply of generated power, from a power generation apparatus which is connected to the power grid, to the power grid; and
a transition control unit which in a first state in which power is not supplied from another power grid to the power grid,
causes the stop unit to stop the supply of the generated power from the power generation apparatus to the power grid, when a first condition is satisfied,
stores a resumption time, from when the supply of the generated power from the power generation apparatus is stopped by the stop unit, to when the supply of the generated power from the power generation apparatus is resumed, and
performs a transition control to transition from the first state to a second state in which the power is able to be supplied from the another power grid to the power grid, based on the resumption time, when a second condition is satisfied.
